(19) United States
(12) Patent Application Publication
(10) Pub. No.: US 2007/0186866 A1
(43) Pub. Date: Aug. 16, 2007

(54) PET PORTAL WITH PATIO

(76) Inventors: Scott Shibles, Concord, NH (US); Michael Kelly, Overland Park, KS (US); Jaedong Kim, Daegu (KR)

Correspondence Address: LATHROP & GAGE LC, 2345 GRAND AVENUE, SUITE 2800, KANSAS CITY, MO, 64108, US

(21) Appl. No.: 11/673,873

(22) Filed: Feb. 12, 2007

Related U.S. Application Data
(60) Provisional application No. 60/773,262, filed on Feb. 14, 2006.

(51) Int. Cl. A01K 1/03

(52) U.S. Cl. 119/484

(57) ABSTRACT

Disclosed is a pet patio which is easily mountable in a window of a dwelling or other enclosed area. Access in and out of the patio is gained by the pet by traveling through a series of flaps. The enclosure area of the patio is substantially apertured and transparent on its sides and the floor. Its top includes an optionally transparent roof which is not apertured so that it deflects rain or other elements. Because the patio walls are substantially apertured, the pet is able to enjoy a near outdoor experience while at the same time the HVAC conditions within the room and dwelling are not significantly affected because the outdoor enclosure is sealed off by multiply-flapped corridor.

### CROSS-REFERENCE TO RELATED APPLICATIONS

This application claims the benefit of U.S. Provisional Application No. 60/773,262, filed Feb. 14, 2006, the contents of which are herein incorporated by reference.

### BACKGROUND OF THE INVENTION

1. Field of the Invention

The present invention relates generally to pet containment systems. More specifically, the present invention relates to window mounted devices which enable a pet to obtain access to outdoor environmental conditions such as sunlight and fresh air without allowing the pet to escape the confines of a dwelling or other containment area.

2. Description of the Related Art

For the owners of many pets, e.g. cats, conflicting interests exist in determining whether it will be allowed to go outside or not. Most pets desire access to the outside so that they can enjoy the elements, such as sunlight and fresh air. This often times becomes impractical, however, where the pet in question is likely to run away, become lost, or be exposed to dangers such as vehicle traffic or predatory wild animals.

In an attempt to overcome this dilemma, prior artisans have developed containment systems which are mounted in a variety of places around the home. In one example, U.S. Pat. No. 5,337,697 issued to Trimarchi et al., a window perch is disclosed which is mounted to the side of the house outside of the window. Angled supports are mounted underneath the sill to support the device from below. This perch enables the pet to walk outside and includes a number of small air holes in a portion at the front top of the device. Pet enclosures such as Trimarchi are somewhat desirable in that they do provide adequate containment for the animal and some exposure to the elements.

There are numerous drawbacks to using such device however. One such drawback is that the amount of fresh air circulated to the animal is limited because of the lack of air exposure. The entire Trimarchi device is enclosed except for two small groups of tiny perforations on the device. These perforations are relatively small allowing little air circulation. Furthermore, none of the perforations are located in the transparent side panels of the device. This creates an internal environment which is nothing like an actual out-of-doors experience. On hot days, the environmental conditions inside the enclosure can be swelteringly unpleasant for the animal.

Another very significant problem with devices such as Trimarchi is that it creates unacceptable heat loss out of the room in which it is installed during the winter and unacceptable heat intake into the room in the summer. Thus the attempts to optimize the Trimarchi design result in a give and take. The designer can increase the number of small perforations to make the environment inside the enclosure more like the actual outdoors. But increasing the air in and out of the enclosure also increases this circulation into the room and dwelling creating the HVAC problems mentioned above. On the contrary, if the designer minimizes the perforation groupings and sizes in an attempt to save heating or cooling costs, the pet will not receive the desired effect inside the enclosure.

This design dilemma has resulted in a need in the art for a device which is not limited by the competing objectives discussed above and is also ornamentally pleasing while remaining functionally satisfying.

### SUMMARY OF THE INVENTION

In one embodiment, the disclosed pet enclosure includes an outdoor patio area for a pet. The transparent walls and floor of the patio are substantially apertured to create excellent air circulation. The patio section is mounted on a portal arrangement which is received in a standard window. The portal arrangement is such that in order to gain access to the enclosure, the pet must travel through at least two flaps. Though these flaps are easily traversed by the pet, they also serve the purpose of sealing off the room in the dwelling from the outside elements. In one embodiment, the patio area has a roof which protects the animal from rain or sleet and is translucent so that the owner is able to look out the window to determine whether the pet is in the patio area, but still is inhibiting enough to block out intense sunlight to protect the animal. In the disclosed embodiment the apertures in the sides and even the floor of the enclosure are uniquely shaped. In the preferred embodiment, the apertures have been uniquely ornamentally shaped as indicia in order to make the device more aesthetically pleasing.

### BRIEF DESCRIPTION OF THE DRAWINGS

FIG. 1 is a perspective view of the present invention in a window mounted installation.

FIG. 2 is a perspective view from the left front of the preferred embodiment of the invention showing it before installation in a window.

FIG. 3 is a perspective view from the right front of the preferred embodiment of the invention showing it before installation in a window.

FIG. 4 is a perspective view from below the preferred embodiment of the invention.

FIG. 5 is a perspective rear left view of the preferred embodiment showing the back of the preferred embodiment.

FIG. 6 is a view of the device from rear left like in FIG. 5 except that the top of the portal portion has been removed to show the internal passageway and flap arrangements.

### DETAILED DESCRIPTION OF THE INVENTION

The advantages of the present invention are many. The disclosed pet enclosure includes numerous apertures in its opaque side walls and is fixedly attached to the front of a portal arrangement which is received in a window. The portal arrangement is such that in order to gain access to the enclosure, the pet must travel through a series of flaps. Though these flaps are easily traversed by the pet, they also serve the purpose of sealing off the room in the dwelling from the outside elements substantially preventing any exposure to the outside because of the installation of the enclosure. Because the portal seals off the room from the outside enclosure, the enclosure is able to be designed such that it is substantially apertured. In the preferred embodiment the enclosure has a roof which is not the only part of the enclosure not apertured, but the roof is transparent so that sunlight can pass to the animal. All of the sides and even the floor of the enclosure contain apertures which are uniquely shaped. In the preferred embodiment, the apertures have been uniquely shaped as indicia in order to make the device more aesthetically and ornamentally pleasing.

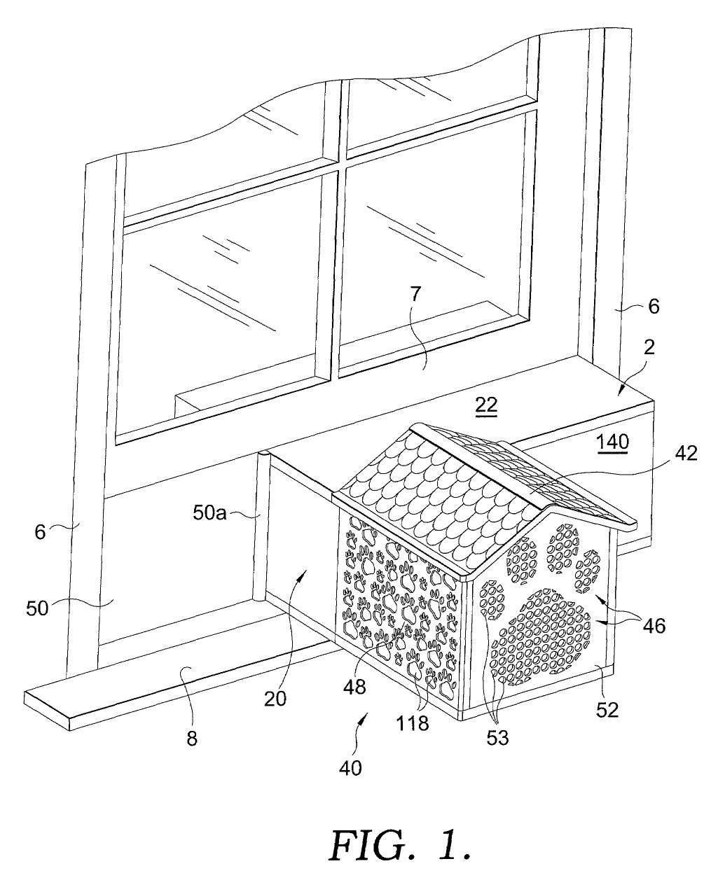

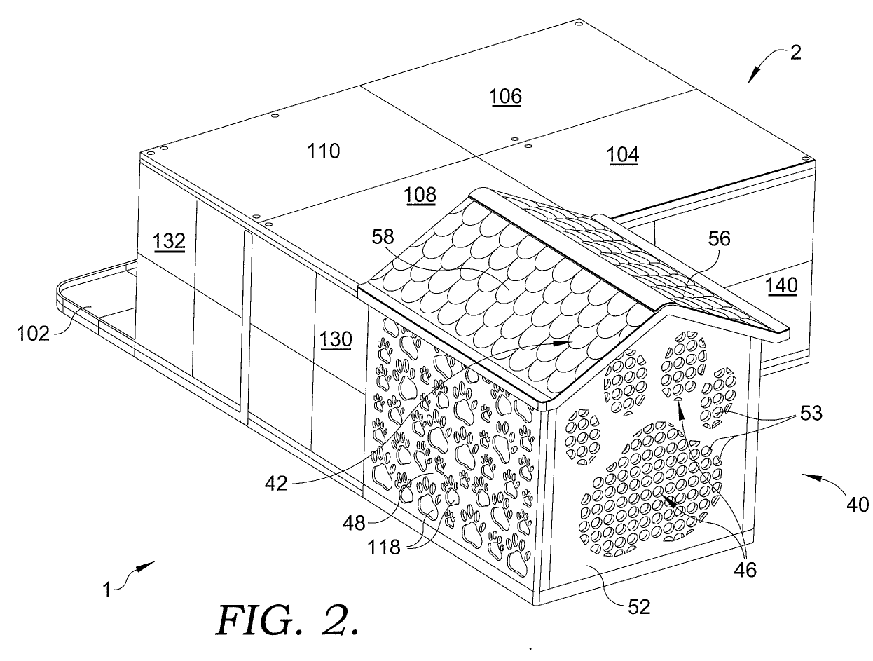

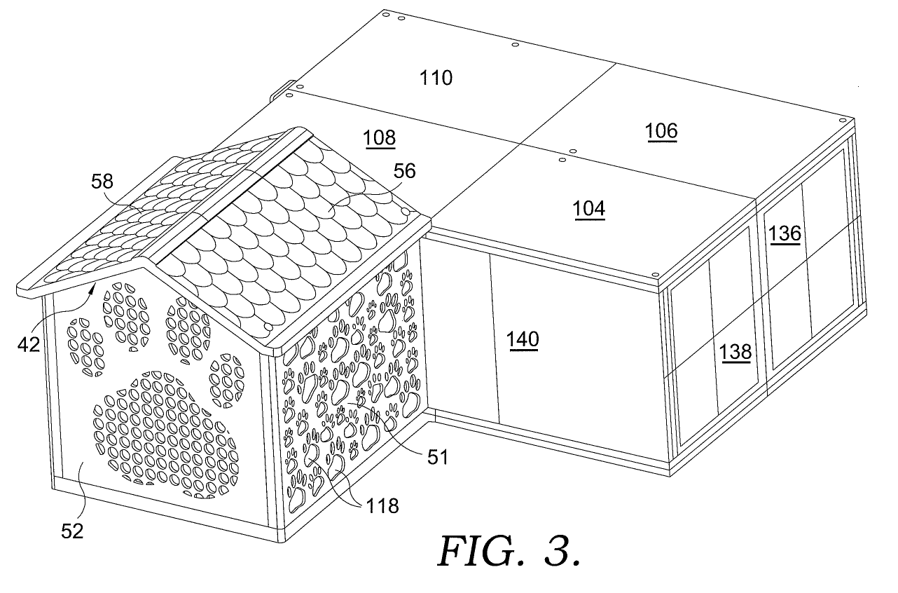

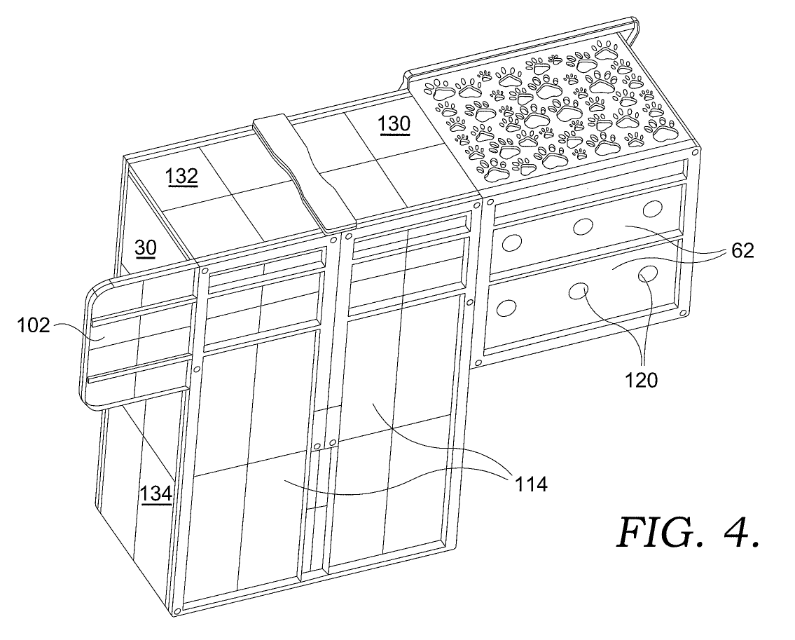

The preferred embodiment of the invention is shown in FIGS. 1 through 6. From these figures it may be seen that the device 1 includes that generally a box-shaped structure having a house-shaped enclosure 40 on its front and a portal portion 2 at its rear. The entire arrangement is adapted such that it is easily installed in the window opening of a house or a dwelling for example, a mobile home, apartment or recreational vehicle. As shown in FIG. 1, the device extends from inside the dwelling to the out of doors. This allows the pet to enter and exit the structure by jumping up on a rear platform 102 and passing through a rear door 30 which opens on a hinge arrangement into the enclosure 40. A sliding lock 31 handle is included on the door. These kinds of arrangements are known in the art. The user can slides the latch 31 to the left to lock, and to the right to open. It includes a horizontally-sliding bar which is received in back panel 134. When the user locks the back door by sliding the lock over, the pet will be unable to enter the portal 2 or patio 40 areas. When slider lock latch 31 is released/open however, the door will swing freely inward. This will enable the pet to use the patio when desired. Latch 31 also enables the user a gripping surface to open and shut the door when it is not latched.

Installed, a housing 20 rests on a window sill 8 and is secured on the sides by a window frame 6. Four top panels 104, 106, 108, and 110 (which are integral with each other in the preferred embodiment) together provide a top wall 22. Sash 7 bears down on top panel 22 to hold it in the window resting atop sill 4. Thus, the portal portion 2 is clamped together between sash 7 and sill 4 to secure the unit in a window (as shown in FIG. 1) with the enclosure 40 sticking outside the window.

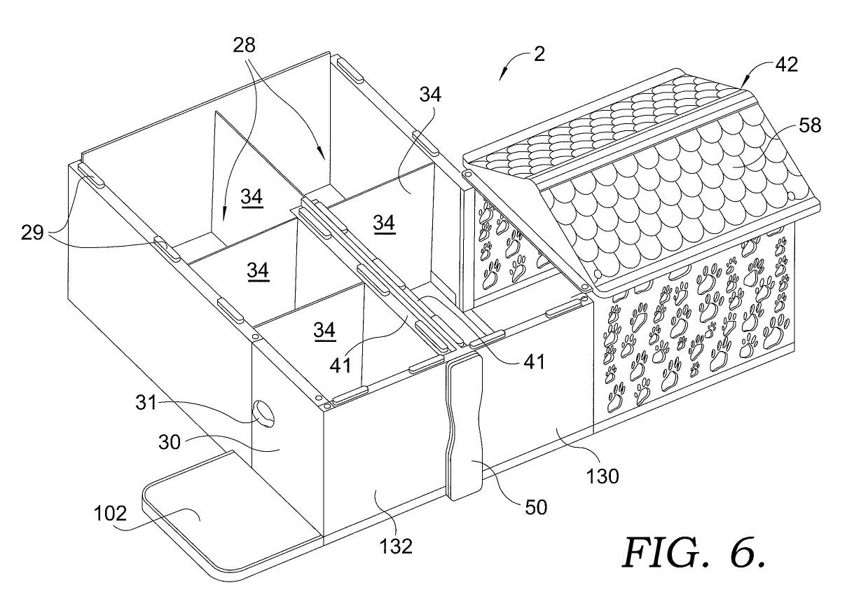

Extension panel 50, which is contained in the structure and may best be seen in FIGS. 1 and 6 is extended outward so that it engages window frame 6. The entire structure is further secured by a window sill 8 and sash 7. Any remaining gap or space between extension panel 50 and window sash 7 at the top or window sill 8 and the bottom may be filled in by a strip of foam rubber (not shown) or other like flexible material capable of being snuggly inserted into the gap and having desirable heat transfer prevention properties. In the preferred embodiment, although not shown in the figures, this foam rubber sealing arrangement (which is intended to be marketed along with the enclosure 40 portal 2 products upon sale) comprises weather stripping tape. One skilled in the art will recognize that this type of adhesive foam rubber tape is commercially available. The tape, when applied about the portal portion 2 and extension panel 50 in all the areas in which window structures are engaged. For example, sealing tape could be used between extension 50 and frame 6, sash 7, and sill 8 on the left; between portal top 22 and sash 7 on top, between one of panels 136 and 138 and the frame (not shown) on the right, and between one of under panels 122 and sill 8 on the bottom (not shown). This sealing arrangement enables the device to be externally sealed off when it is disposed around the exterior such that when the window is down, the exteriors are substantially sealed. One skilled in the art will recognize that the tape could be applied as one continuous strip which fills all of the interfaces discussed above, or alternatively could be applied as separate strips if more convenient. Ideally, however, all of the interface gaps should be filled.

Extension panel 50 may be extended toward or out from housing 20 to accommodate various sized openings. (See FIG. 1). The portal portion 2 may alternatively include an accordion-type sliding frame extension panel (not shown) in a manner similar to the conventional window air conditioner to serve the same purpose as panel 50.

As shown in FIG. 6, the housing 20 includes a number of internal flaps (or doors) 34. But these portions have been removed in FIG. 6.

Flaps 34 are made of vinyl or flexible rubber or the like and are constructed to depend from above within an internal passageway 28. Alternatively, the flaps 34 may comprise a plurality of long strips 34a. Optionally, but not necessarily, flaps 34 or 34a may be weighted at their bottoms with weight devices 34b. These weights help to keep the flaps down and may be more appropriate in regions which windy environmental conditions exist.

When the entire device is assembled, top wall 22 is installed by mounting it atop and fixed to housing 20. The positions of these flaps 34 inside of the portal 2 will be concealed by top wall 22 when it is installed.

At the top of each of wall sections 130, 132, 134, 136, 138, and 140 and also internal dividers 41 are a plurality of upwardly extending tabs 29 (See FIG. 6). These tabs are received in corresponding notches on the undersides of top wall 22 such that it is easily aligned and secured. Once the tabs and notches have been aligned, fasteners or an adhesive are used to secure it. In the preferred embodiment, screws are used along with predrilled holes to securely fasten the lid.

Housing 20 comprises numerous wall portions. The left hand side of the housing comprises two panels 130 and 132. The back of housing 20 comprises door 30 and panel 134. The right hand side of housing 20 comprises two panels 136 and 138. The front of housing 20 comprises a panel 140 which connects up to the patio portion 40. Panels 136 and 138 are transparent in the preferred embodiment whereas panels 130, 132, 134, 136, 138, 140, and door 30 are all opaque in the preferred embodiment, but could alternatively be transparent or translucent.

Each flap, in the preferred embodiment, has a rod at its top which runs horizontally and provides outwardly-extending projections at each top corner. Each projection is received in an aperture located at the top of the side walls. Alternatively, U-shaped notches could be provided at the top of the side walls which would receive each end of the rod for each flap. The notches would then be enclosed by the lid when it was installed. Regardless, for installation, the rod projections for each flap will be matched up with corresponding apertures (or U-shaped notches) such that the flaps hang down into internal passageway 28 (as shown in FIG. 6) of the device 1, fitting snuggly between interior dividers 41 and the internal surfaces of the housing 20 to the sides and upper surface 36 of the floor 114 of housing 20. Now loosely positioned in the internal passageway 28, the flaps 34 act as air locks to minimize the loss of heat from inside the house and to prevent the passage of odors from outside of the house, while also being sufficiently flexible to and moveable by the pet to easily push them aside in the manner of a tent flap, while walking through the structure.

Dividers 41 serve to create internal passageway 28 and also serve to secure extension panel 50 which is able to slide there-between to accommodate different-sized window openings. Extension panel 50 may be locked in place by a secured mechanical or adhesive fixture 50a which could comprise: (i) an L-bracket with screws, (i) tape, or (iii) any other securing means, but in the preferred embodiment shown in FIG. 1, a quarter-round plastic member 50a having a pie-shaped cross section is used. The two planer faces of the member are at a right dihedral angles to one another, and thus, the member fits into the corner between the extension panel 50 and the side of the portal 20 as shown in FIG. 1. The outer planar faces of the member are adapted to include adhesive so that it is able to secure panel 50 in place when installed. Also in the preferred embodiment, covering tape (not shown) is used so that the adhesive will not cure until the tape is removed and the member is ready to be fixed in place, thus locking the 50 into place sealing and laterally stabilizing device 2.

Also seen the figures, is a forward-most patio portion 40 of the device. Patio 40 is accessed through portal portion 2. For this to occur, the pet travels through an internal passageway 28 which is created by the dividers 41 on surface 36. Although not visible in FIGS. 1-5, once the device is assembled, the flaps 34 hang down into the passageway 28 in the positions shown in FIG. 6.

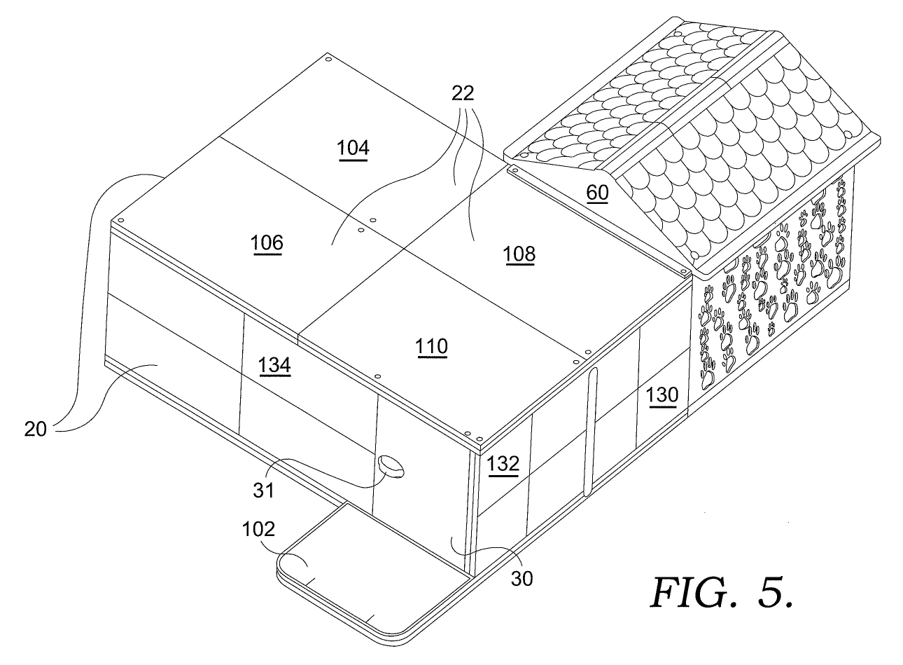

The patio portion 40 is constructed of a left-side panel 48, a right-side panel 51 and a front panel 52 which all are topped by a roof portion 42 which comprises a right-sloping surface 56 and a left-sloping surface 58. Shown in FIG. 5, a back-facing panel 60 closes off the roof from behind. There is also a floor portion 62 of patio 40 which serves to close off the patio area from the bottom.

To enter the patio area, the pet jumps up onto platform 102 and then enters the portal 2 past door 30 (which is unlocked), then is able to walk through passageway 28, systematically passing through/under flaps 34. The pet then moves out onto the floor 62 and enjoy the outside environment inside the patio area 40. The pet cannot, however, escape from the home through the portal area 2 or the patio 40. Thus, it is maintained in the dwelling. Because of this, device 1 is ideal for persons which for numerous reasons listed above desire to maintain their pets within the confines of their home.

That each of walls 48, 51, and 52 as well as floor 62 in the patio are substantially apertured ensures that the pet will be exposed to environmental conditions (e.g. fresh air and sunlight) when desired. In the preferred embodiment each of walls 48, 51, 52 and floor 62 are opaque, but in alternative embodiments they are transparent or translucent. Roof 42 in the preferred embodiment is translucent so that the owner is able to look out the window and see whether or not the pet is in the enclosure, but also the pet is not subjected to too much sunlight on hot days. Alternatively, however, roof 42 could be transparent or opaque depending on the objectives or particular environment in which it is to be used. Second, the patio area is well ventilated. With respect to front plate 52, this is accomplished by providing a plurality of apertures 53 which are included in an overall paw print pattern 46 as shown. Each of sides 48 and 51 have a variety of paw-shaped apertures 118 cut out of the sides to substantially perforate the walls. In a preferred embodiment, the paw prints have a variety of sizes. Further, other shapes could be used for different purposes, e.g., other pets. The use of uniquely identifying shapes to define the apertures gives the device a unique look.

The floor also contains a plurality of apertures 120, however these apertures 120 are not configured in any aesthetically appealing configuration considering that this surface is less likely to be seen than walls 48, 51, and 52. In an alternative embodiment, however, these apertures could be configured in ornamental shapes. In the preferred embodiment, six apertures have been used in the floor.

The various components of the present invention may be constructed of plastic or any other material suitable to achieve the disclosed functional requirements and objectives. In a preferred embodiment; however, the housing and patio area components are constructed of injection-molded thermoplastic. This inexpensive and easily manufactured material also meets the durability requirements so that the device is not damaged by the pet, and more importantly, the pet is not allowed to escape and defeat the overall objectives of the invention.

Though in the preferred embodiment the device is constructed of thermoplastic, alternatively wood, plexiglass, glass, or metal or any other suitable material could be used to construct the housing and still fall within the scope of the present invention.

As can be seen in all of the illustrations, the patio area is substantially apertured except for the roof 42. Roof 42 does not contain apertures so that the elements such as rain, sleet or hail are not able to impact within the patio and cause discomfort for the pet. This enables the pet to go outside of doors even in inclement weather.

Because each of sides 48, 51, and 52 as well as floor 62 are substantially apertured, the pet is almost fully exposed to the environment. This without the assistance of portal arrangement two would create havoc for the HVAC conditions within a room which said device 1 is installed in a window. But with the portal arrangement, and unlike the prior art devices, the device of the present invention substantially prevents heat loss as well as the intake or loss of humidity from the room because the trapped air chambers created in corridor 28 because flaps 34 provide excellent insulation from the elements while at the same time allowing passage of the animal. One of the best deterrents to unwanted heat transfer is trapped air. Thus, the effect of trapping air between flaps 34 is able to substantially prevent heat transfer to reduce heat loss in the winter and heat induction during the summer.

As can be seen, the present invention and its equivalents are well-adapted to provide a new and useful pet patio device and associated method of providing a pet to outdoor environmental conditions while avoiding HVAC losses. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the order described.

The invention claimed is:

1. A pet enclosure device, said device being usable in a dwelling such that it gives access to a pet to outside said dwelling from the inside of said dwelling, said device comprising:
an outside enclosure portion comprising a roof and substantially apertured sides; and
a portal portion on which said enclosure is secured, said portal including at least one sealing device, said sealing device being included in a corridor and environmentally separating said enclosure area from said dwelling.

2. The pet enclosure device of claim 1 wherein said enclosure includes a floor which is substantially includes apertures.

3. The enclosure device of claim 1 wherein said apertures are shaped as indicia.

4. The device of claim 3 wherein said indicia is in the shape of a cat's paw.

5. The device of claim 1 wherein said roof is translucent and aperture-free.

6. The device of claim 1 wherein said sides are one of opaque, translucent and transparent.

7. The device of claim 1 wherein said floor is one of opaque and translucent.

8. The device of claim 1 comprising:
a second sealing device in said corridor, said second sealing device being in series with said first sealing device in said corridor to further environmentally isolate said enclosure area from said dwelling.

9. The device of claim 1 comprising:
an exterior interface sealing member used for the purpose of substantially sealing off a gap between the exterior of said device and a window structure.

10. The device of claim 9 wherein said exterior interface sealing member comprises foam rubber.

11. The device of claim 9 wherein said exterior interface sealing arrangement is adhesive.

12. A pet enclosure device comprising:
a portion of said device which is securable in a window on a dwelling;
an enclosure area attached to said portion, said enclosure area being adapted such that said area is exposed to an outdoor environment;
a passageway through said portion, said passageway adapted to enable a pet to access said enclosure area;
at least one mechanism in said passageway past which said pet must go to enter said enclosure area, while at the same time substantially environmentally sealing off said enclosure area from said room to the extent that the environment within said room is not substantially affected.

13. A pet enclosure device, said device being usable in a dwelling such that it gives access to a pet to outside said dwelling from the inside of said dwelling, said device comprising:
an enclosed outside patio portion;
a portal portion including a passageway to said enclosed outside patio portion, said portal portion being adapted such that it environmentally separates said inside of said dwelling from said patio portion while at the same time granting said pet access to said patio; and
including a sealing member which is included in at least one interface between said device and surrounding window structures to substantially environmentally seal said interface.
